(19) United States
(12) Patent Application Publication
(10) Pub. No.: US 2024/0334950 A1
(43) Pub. Date: Oct. 10, 2024

(54) Plant-Based Cheese Product Comprising Low Solubility Protein

(71) Applicants: Alejandro Marangoni, Guelph (CA); Stacie Dobson, Guelph (CA)

(72) Inventors: Alejandro Marangoni, Guelph (CA); Stacie Dobson, Guelph (CA)

(73) Assignee: University of Guelph, Guelph (CA)

(21) Appl. No.: 18/296,286

(22) Filed: Apr. 5, 2023

(51) Int. Cl. A23C 20/02

(52) U.S. Cl. CPC A23C 20/025

(57) ABSTRACT

A plant-based cheese product is provided comprising a low solubility albumin- or globulin-based protein combined with starch and fat components in an aqueous solution, wherein the amylopectin content of the starch component is at least about 80% w/w.

### FIELD OF THE INVENTION

The present invention generally relates to plant-based products, and in particular, to plant-based cheese products comprising low solubility albumin- or globulin-based protein.

### FIELD OF THE INVENTION

The world's population is expected to reach 9 billion by the year 2050. This means more mouths to feed, and therefore, a higher food demand. Currently, animal proteins and animal by-products such as milk and cheese generate the greatest amounts of greenhouse gas emissions per 100 grams of protein. This coupled with the demonstrably worsening climate crisis means that we cannot continue to rely on animal-based products for our expanding food need. For these reasons along with several ethical quandaries, there has been a shift to more sustainable alternatives in the form of plan-based foods.

The plant-based cheese industry is one of the fastest-growing sectors in food development. However, since current products are lacking both critical functionalities and nutrition compared to their dairy-based counterparts, there remains considerable room for improvement. For individuals consuming a plant-based diet, protein is of utmost importance, but it can be difficult to consume the daily recommendation. Additionally, the lack of similar textural and nutritional value in current products relative to traditional cheese products makes it challenging for the everyday consumer to buy. Finally, plant-based alternatives are typically priced higher than their animal-based counterparts, creating separation in attainability based on socioeconomic standing.

There are many categories when it comes to plant-based cheese, but starch and oil-based cheese are the most popular as they are perceived to have the best melting properties. These products, however, consist mainly of chemically modified ingredients and contain little to no protein.

Thus, there exists a need for an accessible and nutritious plant-based cheese.

### SUMMARY OF THE INVENTION

A novel plant-based cheese product has now been developed. The cheese product comprises low solubility albumin- or globulin-based protein combined with starch and fat to yield a product having physical properties, such as melt and stretch, similar to dairy-based cheese products.

Thus, in one aspect of the invention, a plant-based cheese product is provided comprising a low solubility albumin- or globulin-based protein component combined with starch and fat components in an aqueous solution, wherein the amylopectin content of the starch component is greater than about 80% by weight.

In another aspect, a method of making the plant-based cheese product is provided comprising the steps of: i) combining protein and fat components in an aqueous solution, with or without an emulsifier and/or a starch component, to form an emulsion; ii) adding the starch component, if not added in step i) or optionally adding additional starch component, to the emulsion; and iii) heating the emulsion with stirring and shear for a period of time sufficient to yield a cheese product having cheese-like properties, for example, a hardness within a range of about 15-120N, or a tan δ (G″/G′) of at least about 0.4 at increased temperature.

These and other aspects of the invention are described herein in detail by reference to the following FIGURES.

### BRIEF DESCRIPTION OF THE FIGURES

FIG. 1 provides bright field and polarized microscopy images of A) a sample having a high purity, low solubility protein component (Sample #12), and B) a sample having a high purity, high solubility protein component (Sample #13).

### DESCRIPTION OF THE INVENTION

A plant-based cheese product is provided comprising a low solubility albumin- or globulin-based protein component combined with starch and fat components in an aqueous solution, wherein the amylopectin content of the starch component is greater than about 80% by weight.

The present cheese product comprises a protein component comprising low solubility proteins which are substantially albumin- and/or globulin-based proteins. Low solubility with respect to the protein content is defined herein as a solubility of less than about 30% at a pH of 4-6, preferably, a solubility of less than 25%, 20%, 15%, 10% or 5%. Protein solubility may be determined using methods known in the art, such as the Bradford method, to determine the weight of soluble protein as compared to total protein weight.

A protein component that substantially comprises albumin- and/or globulin-based proteins refers to a protein component comprising at least about 90% albumin- and/or globulin-based proteins, preferably at least about 95% or greater albumin- and/or globulin-based proteins, or a protein component comprising less than about 10% prolamin protein, preferably less than about 5% prolamin. Examples of plant globulin proteins include 7S globulins and 11S globulins, such as but not limited to, conglycinin, glycinin, vicilin, legumin, convicilin, amandin, edestin, concanavalin A and canavalin. Examples of plant albumin proteins include 2S, 7S and 11S albumins.

Sources of a low solubility albumin- or globulin-based protein component include, but are not limited to, legumes such as pea, bean, lentil, chickpea, lupin, mung bean, fava bean, soybean and pigeon pea, nuts such as cashew, almond and peanut, cereals such as wheat, rice, rye, oats, barley and corn, seeds such as pumpkin seed, chia seed, flax seed, hemp seeds, oil crops such as, canola, sunflower, safflower and combinations thereof.

Preferably, the protein component possesses a high purity with respect to protein content. In this regard. “high purity” refers to a protein component having a protein content of at least about 70% by weight protein, preferably greater than about 70%, for example, about 75%, 80%, 85%, 90%, 95% by weight protein or greater. Alternatively, “high purity” with respect to the protein component refers to a protein component comprising less than about 20% of a non-amylopectin starch, such as amylose, preferably, less than 10% non-amylopectin starch.

The present cheese product comprises about 1-25% w/w of the protein component. In one embodiment, the cheese product comprises about 10% w/w protein component or greater. In another embodiment, the cheese product comprises less than about 10% w/w protein component.

The protein component may be treated chemically or enzymatically, may be fermented, or may be hydrolyzed prior to use or during a method of making the present cheese product.

The starch component of the present cheese product comprises an amylopectin content of at least about 80% w/w. Preferably, the starch component comprises an amylopectin content of greater than about 80% by wt. such as about 85%, 90%, 95% or greater % by wt. The starch component may comprise native starch (i.e. not gelatinized) or a mixture of native starch and pre-gelatinized starch. Suitable starches in native form for use in the present cheese product are derived from starch-containing plant parts such as roots, bulbs, tubers, stems and seeds. Thus, sources of starch include cereals, including for example, maize (corn), rice, wheat, sorghum, and barley, tuber plants (stem or root tubers) such as potato, yam, cassava, sweet potato, jicama, sunchokes, seeds such as legume seeds, e.g. kidney bean and the like. Pre-gelatinized starch is starch that has previously been gelatinized and dried to powder form. Pre-gelatinized starch is soluble in water and may comprise up to about 50% of the starch component.

Amylopectin is one of two components of starch, the other being amylose. Amylopectin comprises a linear chain of glucose linked with α(1→4) glycosidic bonds having branched glucose chains which are connected to the linear chain with an α(1→6) glycosidic bond. Amylopectin may comprise 2000 to 200.000 glucose units. Various analytical methods are known to determine amylopectin content of the starch component, and of the total carbohydrates, of the cheese product, including spectrophotometric, gravimetric and X-ray diffraction. Assay kits are commercially available for use to quantify amylopectin content in a given sample. In one embodiment, amylopectin in a starch sample is precipitated (for example, using concanavalin A) from the sample and quantified based on the quantity of amylose in the sample. Amylose may be quantified spectophotometrically based in its interaction with iodine. As one of skill in the art will appreciate, accuracy of detection methods may vary; however, assays for quantifying amylopectin content are expected to be within an acceptable range of experimental error, e.g. less than about 10%, preferably less than about 5%.

The cheese product comprises a starch component in an amount of about 5-50% w/w. It is to be noted that the protein source selected to provide the protein component of the cheese product will generally also comprise carbohydrates, including amylopectin. Thus, the amylopectin content of the total carbohydrate in the cheese product will be greater than that provided by the starch component, comprising amylopectin content from both the starch component and the protein source. Amount of amylopectin of the total carbohydrate content of the cheese product is at least about 80% w/w, and preferably greater than about 80%, for example, about 85% 90% or 95% w/w or greater.

The fat component of the cheese product is not particularly restricted, and may be an edible saturated fat, unsaturated fat (either monounsaturated or polyunsaturated), or a combination thereof. The fat component may be a vegetable fat or oil. Examples of suitable vegetable fats or oils include, but are not limited to sunflower oil, canola oil, safflower oil, soybean oil, avocado oil, olive oil, corn oil, flaxseed oil, almond oil, coconut oil, peanut oil, pecan oil, cottonseed oil, algal oil, palm oil, palm stearin, palm olein, palm kernel oil, rice bran oil, sesame oil, butter oil, cocoa butter, grape seed oil, hazelnut oil, brazil nut oil, linseed oil, acai palm oil, passion fruit oil, walnut oil, tigernut oil, shea butter, shea stearin, shea olein, palm kernel stearin, palm kernel olein, hydrogenate and/or interesterified versions thereof, glycerolysis products thereof, and mixtures thereof. As one of skill in the art will appreciate, the vegetable oils used may vary with respect to their triglyceride content, for example, to provide enhanced oxidative stability. Accordingly, the oil used may be high oleic acid-containing oil such as high-oleic sunflower, high-oleic high-stearic sunflower oil, high-oleic soybean, high-oleic canola, high-oleic safflower oil, hydrogenate and/or interesterified versions thereof, glycerolysis products thereof, and mixtures thereof. The term “high-oleic acid” refers to an oil containing an increased amount of oleic acid as compared to the typical oleic acid content of the oil. This increase may be a 20% or more increase in oleic acid content from typical amount in a given oil.

The fat/oil component comprises about 10-30% by weight of the cheese product. In one embodiment, the cheese product comprises a combination of saturated and unsaturated oil/fat that corresponds with the fat content in cheeses, e.g. a ratio of about 0.5-1 saturated fat to unsaturated fat.

An acid may be added to the cheese product to provide an environment which favourably maintains the low solubility status of the protein component, for example, to provide an environment having a pH in the range of 4-6. Thus, the acid is added to the mixture of cheese product components in amount sufficient to achieve a pH within this pH range. Examples of suitable acids include any food grade acid, such as but not limited to, citric acid, malic acid, lactic acid, tartaric acid, acetic acid, oxalic acid and ascorbic acid.

The cheese product may comprise additional ingredients including, but not limited to, flavorants, fragrances, colorants, preservatives, anti-oxidants, nutrients, fillers, emulsifiers, etc.

Flavorants may include salt, sugar, spices, herbs and the like. Flavorants may also include cheese powders and/or cheese flavors that mimic flavors that result from the breakdown of casein in natural cheese, and may include casein peptides and amino acids that provide a salty, sour, bitter or sweet taste, and free fatty acids such as butyric, lactic and capric acids which provide characteristic cheese flavor. Enzyme-modified cheese flavor may also be used to provide a stronger flavor.

Examples of preservatives that may be used include, but are not limited to, sodium benzoate, sodium and calcium propionate, sorbic acid, ethyl formate, and sulfur dioxide.

Examples of anti-oxidants that may be used include, but are not limited to, ascorbic acid, tocopherols, butylated hydroxyanisole, tert-butyl hydroxyquinone, butylated hydroxytoluene, phenolics, polyphenolics and propyl gallate.

Nutrients that may be included in the present cheese include vitamins (e.g. vitamin A, C, E, K, D, thiamin (vitamin B1), riboflavin (vitamin B2), niacin (vitamin B3), vitamin B6, folic acid (vitamin B9) and/or vitamin B12, and mixtures thereof), and minerals (e.g. calcium, phosphorus, magnesium, sodium, potassium, chloride, iron, zinc, iodine, selenium, copper and mixtures thereof).

Such additional ingredients may each be included in the present cheese product in an amount in the range of 0.01% by weight to about 5% by weight, preferably in the range of about 0.1%-2% by weight of the product.

To alter the consistency of the cheese product, one or more food grade emulsifiers may be added to the product, including but not limited to, surface active compounds such as lecithin, free fatty acids, monoglycerides, diglycerides, polysorbate, sorbitan esters, polyglycerol esters, sucrose esters, sodium stearoyl lactylate, sodium phosphate, calcium phosphate, octenyl succinic anhydride (OSA)-modified starch, ethylcellulose, fatty alcohols, ethoxylated derivatives of alcohols and/or polyols, acid and/or ester derivatives of alcohols and/or polyols, polyphosphates and mixtures thereof. The consistency of the cheese product may also be adjusted with viscosity-enhancing compounds such as gums. Examples of suitable gums include xanthan gum, locust bean gum, guar gum. Arabic gum, carrageenan, gellan gum, flaxseed gum, konjac gum and mixtures thereof. The addition of one or more emulsifiers and/or viscosity-enhancing compounds is suitable to render a more creamy product or less dry product. These compounds may be included in the present cheese product in an amount in the range of 0.1% by weight to about 1% by weight, preferably in the range of about 0.2%-0.7% by weight of the product, including, 0.3%, 0.4%, 0.5% and 0.6% by weight of the product.

The cheese product may also include a filler to provide volume/bulk to the cheese product while not impacting desired properties, such as rheological melting properties, hardness, stretch, shape and sliceability. Examples of suitable fillers for this purpose include, but are not limited to, consumable inert components such as microcrystalline cellulose, maltodextrin, dextrin, inulin, sugars, fibers and mixtures thereof. The filler may be included in the cheese product in an amount in the range of about 1-15% by weight of the cheese product, preferably about 2.5-10% by weight.

The balance of the cheese product is an aqueous solution which may be water, or an aqueous solution such as a flavoured water or stock. The cheese product comprises at least about 30% by wt aqueous solution, such as at least about 40% by weight, e.g. at least about 50%, 60%, 70% or more. Preferably the amount of aqueous solution in the cheese product is in the range of about 40-60% by weight of the cheese product. As one of skill in the art will appreciate, water content will vary with the desired characteristics of the end product. For example, a softer cheese product will generally include an increased amount of water (e.g., 50% by weight or more), while a harder cheese product will generally include less water (e.g., less than 50% by weight, such as 40-45% by weight).

In another aspect of the present invention, a method of making the plant-based cheese product is provided comprising the steps of: i) combining protein and fat components in an aqueous solution, with or without an emulsifier and/or a starch component, to form an emulsion; ii) adding the starch component, if not added in step i) or optionally adding additional starch component, to the emulsion; and iii) heating the emulsion with stirring and shear for a period of time sufficient to yield a cheese product having cheese-like properties, for example, a hardness within a range of about 15-120N. or a tan δ (G″/G′) of at least about 0.4 at increased temperature.

Generally, the protein component, in the form of a powder or a suspension, is combined with the fat component and aqueous solution to form a mixture which is homogenized to form an emulsion. If required, the fat is first melted prior to its addition to the mixture. If protein is in the form of a powder, dry protein can be combined by adding smaller portions of the protein powder to the mixture to prevent clumping. The starch component may be combined with the fat prior to emulsifying, or may be added to the emulsion mixture, or a combination of both. As with the protein, the starch may be added in smaller portions to the mixture to facilitate incorporation of the starch into the mixture. If desired, the protein may be treated and/or modified, either prior to its combination with other components, or subsequent to its combination with other components such as the fat component and/or aqueous solution. Modifications to the protein may include chemical or enzymatic modifications, full or partial hydrolysis and/or fermentation.

Once the protein, fat and starch components are combined with the aqueous solution to form an emulsion, the emulsion is exposed to heating with mixing for a period of time sufficient to induce partial or full gelatinization of the starch to yield a cheese product having cheese-like properties, for example, a hardness within a range of about 15-120N, and/or melting characteristics such as a tan δ (G″/G′) of at least about 0.4 at increased temperature. Thus, heat is applied to the mixture at a temperature which converts the components into a cheese-like product when allowed to set, for example, a temperature that is sufficient to cause gelatinization of the starch component (for example, a temperature that is above the gelatinization temperature of the starch component). In one embodiment, the temperature may be greater than about 60° C. and less than about 90° C. Mixing during heating will generally be at a moderate speed, with increased speeds at points throughout the process. e.g. at about midpoint of the process to promote combination of the components and to prevent uneven heating. The mixture is heated for a period of time sufficient to achieve the desired properties of the cheese product, for example, to achieve the desired hardness of the cheese product. As one of skill in the art will appreciate, temperatures, mixing speeds and times will vary with the mixing equipment utilized, and the scale of the process used.

Following mixing with heating, the cheese mixture is in a fluid molten state. The fluid cheese is then poured into a mould and refrigerated for a period of time to solidify or set the mixture, for example, at a temperature of <10° C. The cheese is stored at refrigeration temperatures to maintain the desired solid state. The final cheese product may be in the form of a block, either a large block used for slicing, or smaller blocks. e.g. portion-sized, or may be processed to form slices or shreds, depending on the desired end use of the product.

The present cheese product advantageously possesses properties which render it to be similar to natural dairy cheese, including properties of stretch, melt, hardness and melt profile (tan δ(G″/G′)).

The extensibility/stretch of the cheese product, determined based on the stretch of the product following heating until its breakpoint, is desirably within the range of dairy cheese product. For example, the present cheese product exhibits a stretch as measured using a rotational rheometer of at least about 30 mm, and preferably greater. e.g. 40 mm, 50 mm, 60 mm, 70 mm, 80 mm, 90 mm or more.

Regarding melt or loss of shape, the cheese product exhibits melting measured by an increase in the dimension(s) of its shape when exposed to an increase in temperature. The increase may be an increase in a dimension such as, but not limited to, diameter, cross-section or length. For example, the cheese product, when in the shape of a cylinder exhibits an increase in diameter at increased temperature, for example, at 200° C. or greater, e.g. an increase in diameter of at least 50% or greater, e.g. 80-100%, 120-150%, or greater.

The present cheese product also exhibits a texture or hardness similar to that of dairy cheese. Hardness is determined based on the maximum force recorded during the first compression of a double compression cycle. The hardness of the cheese product will vary depending on the desired end product, e.g. a softer cheese or a harder, gradable or sliceable cheese. Generally, the hardness of the cheese product is within the range of about 15-120N, preferably within a range of 20-85N.

The melting profile of the present cheese product is also improved in comparison to that of existing commercially available plant-based cheeses, exhibiting a melting profile that approaches that of dairy cheese, for example, the tan δ (G″/G′) of the present cheese product increases on heating to a value of at least about 0.4, preferably at least 0.5, 0.6, 0.7 or greater.

The properties of the present product may be altered to provide a product that corresponds with a particular type of cheese, for example, semi-hard cheese, e.g., cheddar, swiss and gouda cheese, hard cheese, e.g. parmesan or asiago, semi-soft cheese. e.g., Havarti or Jarlsberg, stretched curd cheese, e.g., mozzarella or provolone cheese, or soft cheese, e.g., Brie or gorgonzola. For example, water and fat content may be altered to provide a harder or softer variety of cheese. e.g. by increasing solid fat content to provide a harder cheese, or increasing liquid fat content and/or water content to pro % ide a softer cheese. Protein type may also be altered, as well as amount of filler and/or emulsifier, to provide a product with a desired melt rheology and/or stretch.

While not wishing to be limited to any particular mode of action, the present cheese product is believed to exhibit desirable cheese-like properties due to the microstructure of the product due at least in part to the incorporation of a high purity low solubility the protein component. Such a protein component is less interactive (reduced surface activity) when combined with the components of the cheese product. This reduced surface activity minimizes aggregation of components within the matrix of the cheese product, resulting in a more homogenous microstructure comprising spherical elements (e.g. air and fat globules) which are more evenly distributed throughout the structure, and which permit proper gelatinization of the starch to yield the desirable melt and stretch characteristics of the cheese product.

As used herein, the term “about” is meant to refer to the indicated value plus or minus an amount which is expected to result in a similar outcome, for example, an amount which greater than or less than the indicated value by about 10%.

Embodiments of the invention are described in the following specific examples which are not to be construed as limiting.

### Example 1—Methods for Making and Analyzing a Cheese Product

Method #1—The following method was used to make a cheese product containing greater than 10% w/w protein ingredients as set out in Table 1.

TABLE 1

| Protein | Fat | Starch | Aqueous |
|---|---|---|---|
| % w/w | % w/w | % w/w | % w/w |
| 18 | 21 | 12 | 49 |

The total volume of water was put into a large beaker followed by the addition of the appropriate amount of dry protein to make a 1-5% (w/v) protein solution. The solution was then stirred on a stir plate at 400 rpm until combined. The fat (coconut oil) was then melted using a microwave, added to the protein-water solution and homogenized at 20,000 rpm using a Polytron handheld homogenizer for 1 min. to form an emulsion. The emulsion may also be formed in a thermomixer at speed 5 (500 rpm) for 1 min. The emulsion was then mixed in a Thermomix TM6 at speed 2-2.5. During this time, the remaining protein and half of the dry starch (waxy maize) were added to the thermomixer, and mixed until fully combined (no dry powder remaining). Citric acid solution (1M) was added in an amount sufficient to attain a pH of 4-6 and mixed for 30 sec followed by the addition of the remaining dry starch. Mixing was continued until the composition was smooth, stopping to scrape the sides when necessary to ensure complete mixing.

Once completely smooth, the composition was heated using the following protocol in a thermomixer:
Set Speed to 2.0
   1—Set temperature to 40° C.
   2—Upon reaching 40° C., increase to 50° C.
   3—Upon reaching 50° C., increase to 60° C.
   4—Upon reaching 60° C., increase to 70° C.
   5—upon reaching 70° C., stop and scrape bottom
Set speed to 0.5
   1—Set temperature to 80° XC
   2—Upon reaching 80° C., stop and scrape bottom
Set speed to 0.5
   1—Set temperature to 80° C.
   2—Run for 30 s
   3—Stop and scrape bottom
Set speed to 3.5
   1—Set temperature to 80° C.
   2—Run for 30 s
   3—Stop and scrape bottom
Set speed to 0.5
   1—Set temperature to 80° C.
   2—Run for 90 s
   3—Stop and scrape bottom
Set speed to 0.5
   1—Set temperature to 80° C.
   2—Run for 90 s
   3—Stop and scrape bottom

The sample was further heated at 80° C. according to the following speed ramp:
i) Set speed to 0.5 for 30 s
ii) Set speed to 2.0 for 30 s
iii) Set speed to 3.5 for 30 s
iv) Set speed to 2.5 for 30 s
v) Set speed to 1.5 for 1 min

The above provided sample T1 (Time 1-Sample 1) at a time of about 14 minutes. T2 to T7 samples were sequentially obtained by additionally mixing the sample at speed 0.5 at 80° C. for 2 min. scraping the bottom of the sample to obtain samples at 16 min, 18 min, 20 min, 22 min, 24 min and 26 min. All samples were refrigerated for 24 h at 4-5° C.

Method #2—This method was used for making a cheese product containing less than 10% w/w protein ingredients in the formulation. It essentially corresponds with the above method except that the amount of dry protein added was an amount to make a 1% (w/v) protein solution. Following addition of the starch component, lactic acid (in an amount sufficient to lower pH to 4-6) and NaCl (in an amount of about 1% or less of the sample) were added and mixed for 30 sec followed by the addition of the remaining dry protein and starch.

The sample was exposed to the same heating protocol as set out above with two additional 90 s heating periods at 80° C. at speed 0.5. The speed ramp was also adjusted as follows: the temperature was set at 80° C., and 1) speed was set to 3.5 for 30 s followed by 2) speed at 1.5 for 1 min. This was sample T1 (Time 1-Sample 1) usually ˜14 min.

T2 to T11 samples were sequentially obtained as described above at 16 min, 18 min, 20 min. 22 min, 24 min. 26 min. 28 min, 30 min. 32 min and 34 min. All samples were refrigerated for 24 h at 4-5° C.

### Protein Assessment

Protein purity—A Dumas nitrogen analyzer (Leco-FP-528. LECO Corporation. USA) was used to determine the nitrogen content of the protein samples. The overall protein purity was calculated using the conversion factor of 6.25 (J. Boye et al., 2010; Osen et al., 2014). The measurement was repeated at least in duplicate. Protein purity reflects the total amount of protein in the formulation determined by Dumas analysis. The protein content of the final cheese product is based on amount of protein ingredient in the formulation and the purity of the protein. For example, if the formulation contains 18% w/w protein ingredient and the protein ingredient has purity of 80%, the corrected protein value is 14.4% w/w.

Protein solubility—Protein solubility was measured using the Bradford method (Bradford, 1976). The supernatant (20 μL) was mixed with the Bradford reagent (940 μL) and allowed to react for 15 min. Absorbance was measured on an absorbance spectrometer (Duetta, HORIBA Scientific, USA; or UV-Visible Spectrophotometer, model UV-1601, Shimadzu. Kyoto, Japan) at 595 nm. Bovine serum albumin was used to generate a standard curve. Protein solutions were prepared at pH less than 6 at the appropriate concentration to ensure absorbance values were not beyond the limit of detection. Protein solubility was expressed as the g of soluble protein per g of total protein. The total protein purity was determined using the Dumas nitrogen analyzer described above.

### Cheese Analysis

Texture Analysis (Hardness)—Texture profile analysis (TPA) is a standard technique used to obtain sensory characteristics of food. TPA mimics the first two bites of chewing by compressing the food to a desired level of deformation. The test was ultimately used to determine the sample hardness. For the analysis of hardness of the cheese products, samples were prepared using a cylindrical die cutter with a 20 mm diameter 20 mm, followed by trimming to 10 mm in height. For commercial samples that were pre-sliced, the die cutter was used to cut samples which were then stacked to reach 10 mm in height. All samples were kept at 5° C. and analyzed within 1-5 min of being cut. The sample disks were analyzed using a TA.XT2 texture analyzer (Stable Micro systems, Texture Technologies Corp. Scarsdale, NY, USA) fitted with a 75 mm cylindrical plate and 30 kg load cell. The samples were compressed to 50% of their original height at a crosshead speed of 1.00 mm/s with 5 sec rest between compressions. The data was recorded in newtons and analyzed using Exponent software.

Disk melt test (modified Schreiber test) (spread)—The meltability of the cheese was measured using a modified Schreiber test. Samples were cut with a cylindrical 20 mm die cutter, and then trimmed to be 10 mm in height. Samples that were in slice form were cut to be the same 20 mm in diameter and stacked to be 10 mm in height. The samples were kept at 5° C. A paper template 100 mm in diameter printed with increasing concentric circles as well as lines at 45° angles was placed at the bottom of each petri dish facing up. The sample was then placed on top of the template and covered with the corresponding glass top and placed in the refrigerator at 5° C. for 10 min. The samples were then transferred to an oven pre-heated to 232° C. (450° F.) for 5 min, removed and allowed to cool before the diameter of the spread at four different angles was taken. The average of the measurement was used to calculate the meltability by determining the % increase in diameter from the initial 20 mm.

Oil loss—Oil loss for the samples was measured based on the saturation of Schreiber disk paper that occurred during the melt. A numeric value from 1-7 was allotted based on the number of rings on the paper that were saturated with oil. The value was then converted to a percent.

Rheology for plant-based cheese with greater than 10% w/w protein ingredient in the formulation—Oscillatory shear strain tests and temperature sweeps were performed using a rotational rheometer (MRC 302, Anton Paar. Graz, Austria) fit with a 20 mm parallel plate geometry (PP20/S). To avoid slip the top and bottom plates were affixed with 40 and 600 grit sandpaper, respectively, and a small amount of super glue was used to adhere the sample. The samples were less then 3 mm in height and were compressed between the plates with an axial force not exceeding 5 N. The normal force was then reduced to 0.25 N and held for 3 min to allow the sample to relax. Peltier plates and a forced air hood (Anton Paar. Graz, Austria) were used to control the temperature. Amplitude sweeps were first performed at 5° C., 25° C. and 50° C. on commercial Kraft Single slices to determine the liner viscoelastic region (LVR). The sweep was performed at a logarithmic rate from 0.01-200% strain as a constant frequency of 1 Hz. A frequency sweep from 1-10 Hz was then carried at 0.1% strain.

To investigate the melting profile of the cheeses, a temperature sweep from 5-80° C. at a rate of 5° C. per min was carried out at 0.1% strain, at a frequency of 1 Hz with a constant normal force of 0.25N to adjust for sample melting.

The variables obtained for all tests were elastic modulus (G′), loss modulus (G″) and tan δ (G″/G′) and the data was analyzed using RheoCompass Software. tan δ (G″/G′) at 80° C. was used for comparison across samples for meltability. The greater the tan δ value, the greater the meltability.

Axial pull (Stretch—The extensibility/stretch of the cheeses were measured using a rotational rheometer (MRC 302, Anton Paar, Graz, Austria) with Peltier plates and a forced air hood (Anton Paar, Graz, Austria) used for temperature control. The rheometer was fit with a 20 mm parallel plate geometry (PP20/S) and pre heated to 80° C. To avoid slip the top and bottom plates were affixed with 40 and 600 grit sandpaper respectively and a small amount of super glue was used to adhere the sample. 5 mm samples were used and compressed between the plates with an axial force not exceeding 5 N. The normal force was then reduced to 0.25 N. The samples were held for a total of 6 min at 80° C. with a constant 0.1% strain and applied normal force 0.25N. The applied force ensured constant contact with the sample during melting but the gap decrease was limited to a height of 3 mm. After heating, an axial pull was performed where the top parallel plate geometry moved upwards at a speed of 1500 um/s. The Normal force (N) and Gap (mm) was recorded during the pull using RheoCompass Software. Additionally, a video recording of the axial pull was done using the camera of an iPhone XS (Apple Inc.). The gap size of the instrument was recorded in the same frame as sample stretch, and the gap at which the sample broke was used as the break point. Total stretch was measured by the following equation.

$$Stretch ( mm ) = Breakpoint ( mm ) - Starting gap after heating ( mm )$$

Rheology for plant-based cheese with less than 10% w/w protein ingredient in the formulation—Shear rheological measurements and temperature sweeps were performed using a rotational rheometer (MRC 302. Anton Paar, Graz. Austria) fitted with a 20 mm parallel plate geometry (PP20/S). To avoid slipping, the top and bottom plates were affixed with 40 and 600 grit sandpaper respectively. Peltier plates and a forced air hood (Anton Paar, Graz, Austria) were used to control the temperature.

Cheese samples were shredded using manual drum grater (Starfrit, Atlantic Promotions Inc, Longueuil, QC, CAN) and shredded until no more whole shreds fell from the drum. Two (2) grams of shredded cheese sample were placed in a small circular mold 2.5 mm in diameter placed at the bottom plate of the rheometer.

The measuring system was lowered to a set gap of 6 mm to compress the sample into a disk. The normal force did not exceed 5N and was further relaxed to 0.25N. Mineral oil was applied around the edges of the sample to prevent drying. The force was changed to 5N and 1 mm in height, then reduced to 0.25N to allow the sample to relax. A temperature sweep from 20-95° C. at a rate of 5° C. per min was carried out at 0.1% strain, at a frequency of 11 Hz with a constant normal force of 0.1N to adjust for sample melting. The variables obtained for the temperature sweep were elastic modulus (G′), loss modulus (G″) and tan δ (G″/G′) and the data was analyzed using RheoCompass Software. Following the temperature sweep, the sample was then held at 95° C. for 3 min and an axial pull measurement was performed. The top parallel plate geometry moved upwards at a speed of 1500 um/s. The gap (mm) was recorded during the pull using RheoCompass Software. Additionally, a video recording of the axial pull was done using the camera of an iPhone XS and or 12 (Apple Inc.). The gap size of the instrument was recorded in the same frame as sample stretch, and the gap at which the sample broke was used as the break point. Total stretch was measured as noted above.

The carbohydrate content of the cheese is the combined amount of carbohydrate coming from the starch and protein ingredients.

### Example 2: Comparison of Commercial Dairy and Plant-Based Cheese

Commercial dairy and plant-based cheese were compared in terms of composition (see Table 2).

TABLE 2
Composition of commercial dairy and plant-based cheeses

| | | Protein | | |
|---|---|---|---|---|
| | | Content | | Total |
| | | of cheese | Fat | carbohydrate |
| Sample # | Sample name | (%) | % | (%) |
| 1 | Kraft Single | 16 | 21 | 11 |
| 2 | Medium Cheddar | 23 | 37 | 0 |
| 3 | Mozzarella | 23 | 27 | 3 |
| 4 | Daiya Cheddar | 0 | 23 | 18 |
| 5 | VioLife Cheddar | 0 | 23 | 20 |
| 6 | Earth Island | 0 | 23 | 20 |
| | Cheddar | | | |
| 7 | Sheese Cheddar | 0.3 | 24 | 20 |

Functional properties of the dairy and plant-based cheeses were determined using the methods as outlined in Example 1 (Table 3).

TABLE 3
Functional properties of commercial dairy and plant-based cheese

| | | | | | tan δ @ | |
|---|---|---|---|---|---|---|
| | | Hardness | Melt | Oil | final | Stretch |
| Sample # | Name | (N) | % | loss | temp | (mm) |
| 1 | Kraft | 22.10 | 144.69 | 0 | 1.34 | 31.48 |
| | Single | | | | | |
| 2 | Mild | 63.02 | 143.75 | 96.96 | 1.94 | 95 |
| | Cheddar | | | | | |
| 3 | Mozzarella | 43.577 | 135.00 | 87.32 | 1.39 | 74.05 |
| 4 | Daiya | 55 | 1 | 0 | 0.162 | 8.20 |
| | Cheddar | | | | | |
| 5 | VioLife | 119 | 14 | 0 | 0.104 | 11.90 |
| | Cheddar | | | | | |
| 6 | Earth | 103 | 3 | 0 | 0.088 | 6.01 |
| | Island | | | | | |
| | Cheddar | | | | | |
| 7 | Sheese | 106 | 21 | 0 | 0.163 | 18.49 |
| | Cheddar | | | | | |

Commercial dairy cheese Samples #1-3 results—Hardness is a measure of the mechanical strength of the cheese is obtained through texture profile analysis which mimics the first two bites of chewing and provides. The hardness values vary significantly across samples #1-3. Kraft singles were the softest, followed by mozzarella, and then cheddar cheese. The different degrees of hardness demonstrate that not all dairy cheese is made equally, and the hardness values need to be considered when making a plant-based alternative. The meltability of the cheese is expressed as a percentage and relates to the increase in sample spread/area after heating. The melting values for dairy cheese are quite high with a minimum melt of 135% for processed cheese and greater for cheddar. Oil loss is a common property in dairy cheese due the high saturated fat content. Mild cheddar and mozzarella had large amounts of oil loss while the processed cheese exhibited no oil loss. No loss of oil can be attributed to the added emulsifiers (phosphates), including sodium and calcium phosphate, in processed cheese which aids in emulsification. Tan δ at 80° C. or 95° C. is a value obtained through rheological melt analysis and indicates how viscous the sample gets during heating. The numeric value can be related to the degree of melt that has occurred. As the tan δ value approaches and/or surpasses 1, the sample becomes increasingly viscous and demonstrates better melt. The tan δ value for all of the dairy samples #1-3 is greater than 1 indicating significant sample melt. Mozzarella and processed cheese have similar tan δ values, while the tan β for cheddar was closer to a value of 2 indicating even greater amounts of melt. Cheddar had the greatest stretch, followed by mozzarella and the Kraft single had the smallest stretch.

Thus, commercial dairy samples (Sample #1-3) display high protein contents, greater than or equal to 16% protein; fat content ringing from 21-37%; limited carbohydrate content, with the exception of a Kraft single which is a processed cheese product (contain a portion of natural diary cheese and additional ingredients (i.e. carbohydrates) and phosphates to help emulsify and stabilize the systems).

Commercial plant-based cheese samples #4-8 results—The hardness of the commercial plant-based samples range from 55 to 119N. Only sample #4 is comparable to the hardness values seen for dairy cheeses. All additional commercial samples #5-7 have significantly greater hardness values than the dairy cheeses. The meltability of the commercial plant-based samples was very low only reaching a maximum of 21% spread. The poor meltability indicates that the commercial plant-based samples are not able to melt or provide the same organoleptic properties associated with dairy cheese. The commercial plant-based cheese exhibited no oil loss. While this feature may be desirable, it indicates the samples behave similar to a processed dairy cheese. Oil loss is significant in dairy cheese, which may not be undesirable since it may attribute to a better mouth feel and lubricity. Tan δ at 80° C. for the commercial plant-based cheeses #4-7 were low reaching a maximum of only 0.163. The low tan δ value indicates poor meltability. The samples did not become viscous or elastic. When compared to the melt of dairy cheeses which reached a minimum tan δ value of 1.3, the commercial plant-based samples do not compare favorably. The stretch of the commercial plant-based samples was also very minimal compared to dairy cheese with only sample #8 reaching a maximum stretch of 18.5 mm. While this value is approaching that of a Kraft single at 32 mm stretch, it is noted that sample #8 lacks in other functional properties (i.e. melt, spread, hardness).

Commercial plant-based samples (Sample #4-7) differed significantly from diary cheese. The plant-based cheeses had very low protein content (1% protein or less, with most of the cheddar cheese analogues having 0% protein); significantly greater carbohydrate content than dairy cheese; and fat content ranging from 23-24% similar to processed cheese.

Summary: Commercial plant-based cheeses samples #4-7 are lacking many of the functional properties possessed by dairy cheese samples #1-3. The plant-based samples do not have similar hardness values, they have limited spread during melt, limited meltability into a viscous state and lack extensibility.

### Example 3: Novel Plant-Based Cheese Product with Varied Proteins

Novel cheese formulations comprising greater than 10% by wt protein (see Table 4), each comprising different protein ingredients, were evaluated for effect on the functional properties of the cheese. Cheese samples #8-11 were prepared according to Method 1 as described in Example 1 with an initial emulsion of an aqueous protein component (<1% w/w) and coconut oil. The remaining dry protein and starch were then added followed by a heated mixing regime comprising both low and high shear intervals. The samples were heated for two different durations of time indicated as Time 4 and Time 7. The different heating times allow for the development of different functional properties of the cheese systems. The formulation of the plant-based cheese samples #8-11 were as follows: 18% by wt protein component, 21% by wt fat (refined coconut oil) component, 12% by wt starch (100% native waxy maize) component and 49% by wt deionized water. Citric acid was added to reach pH 5.5. The nutritional value of the cheese products made are set out Table 4.

TABLE 4
Nutritional composition for plant-based cheese sample #8-11

| | | | | | | Starch | | Amylopectin |
|---|---|---|---|---|---|---|---|---|
| | | Protein | Protein | Corrected | | ingredient | | content of |
| | | ingredient | ingredient | protein | | in | Total | total |
| | | purity | % | content of | Fat | formulation | Carbohydrate | carbohydrate |
| Sample # | Protein | (%) | w/w | cheese (%) | % | % | (%) | (%) |
| 8 | Pea-A | 77.62 | 18 | 14 | 21 | 12 | 16.00 | 84.7-89.2 |
| | (NUTRALYS ®, | | | | | | | |
| | ROQUETTE) | | | | | | | |
| 9 | Lupin | 91.86 | 18 | 16.53 | 21 | 12 | 13.47 | 91.1-93.1 |
| 10 | Pea-B | 53.42 | 18 | 9.62 | 21 | 12 | 20.38 | 77.5-84.9 |
| | (VITESSENCE ™ | | | | | | | |
| | Pulse 1550 | | | | | | | |
| | Protein, Ingredion | | | | | | | |
| | Inc.) | | | | | | | |
| 11 | Faba-A | 57.81 | 18 | 9.87 | 21 | 12 | 19.5 | 78.6-85.5 |
| | (VITESSENCE ™ | | | | | | | |
| | Pulse 3600 | | | | | | | |
| | Protein, Ingredion | | | | | | | |
| | Inc.) | | | | | | | |

The properties of the different protein components in each of the samples are set out in Table 5 below.

TABLE 5
Categorization of protein ingredients in plant-based cheese samples # 8-11

| | | | Protein | Low | High | Low | High | Good |
|---|---|---|---|---|---|---|---|---|
| | Protein | Protein | Solubility | protein | protein | solubility | solubility | Cheese |
| | ingredient | Purity | @pH 5.5 | purity | purity | @pH | @pH | Properties |
| Sample # | Name | (%) | (%) | (<70%) | (>70%) | 5.5((<30%) | 5.5((>30%) | (Y/N) |
| 8 | Pea-A | 77.62 | 4 | | ✓ | ✓ | | Y |
| 9 | Lupin | 91.86 | 56 | | ✓ | | ✓ | N |
| 10 | Pea-B | 53.42 | 3 | ✓ | | ✓ | | N |
| 11 | Faba-A | 57.81 | 60 | ✓ | | | ✓ | N |

The functional/mechanical properties of the plant-based cheese formulations were determined at two different processing times, T4 and T7.

Results achieved at T4 are set out below:

TABLE 6
Mechanical cheese properties at T4

| | Protein | Hardness | Melt | Oil loss | tan δ @ | Stretch |
|---|---|---|---|---|---|---|
| Sample # | type | (N) | (%) | (%) | 80 C. | (mm) |
| 8 | Pea-A | 21.34 ± 1.82 | 120.40 ± 7.16 | 92.86 ± 7.14 | 0.701 | 36.94 |
| 9 | Lupin | 11.22 ± 5.37 | 8.50 ± 9.849 | 14.286 ± 16.50 | 0.422 | 16.89 |
| 10 | Pea-B | 10.35 ± 3.97 | 11.25 ± 14.65 | 56.01 ± 18.35 | 0.456 | 15.89 |
| 11 | Faba-A | 10.05 ± 2.94 | 21.20 ± 10.62 | 60.54 ± 4.35 | 0.488 | 18.94 |

The hardness of the cheese samples differ based on the protein used. Sample #8 which has high protein purity and low protein solubility has the greatest hardness value. Samples #9-11 have significantly lower hardness values. When comparing the results to dairy cheese (Table 3), the hardness value for sample #8 is very similar to that of a Kraft single, which is a parameter none of the current commercial plant-based samples were able to achieve.

The melt of the samples follows a similar trend, with sample #8 having the greatest melt at 120% spread, compared to sample #9-11 which are made with the other proteins, and only have a maximum 21% spread. The degree of melt seen by sample #8 is superior to all of the current commercial plant-based samples and is approaching the values seen by dairy cheese. Sample #8 did however exhibit the greatest oil loss, reaching values similar to dairy cheese. Samples 10-11 had the next greatest oil loss and Sample #9 displayed significantly lower oil loss. The rheological melting analysis demonstrated that sample #8 had the greatest tan δ value at 80° C. of 0.7 indicating the sample had the greatest melt and displayed more viscous behavior. The tan δ of sample #8 is approaching values seen in dairy cheese. Samples 9-11 had lower tan δ values ranging from 0.42-0.48, however, these values were increased in comparison to commercial plant-bused cheeses as shown in Table 2. Sample #8 displayed the greatest stretch of 37 mm, while samples #9-11 stretched less only reaching between 16-19 mm. The extensibility of sample #8 is similar to that of processed dairy cheese (Sample #1).

The functional properties for samples #8-11 at T7 are shown below and followed a similar trend to what was observed at T4.

TABLE 7
Mechanical cheese properties at T7

| | Protein | Hardness | Melt | Oil loss | tan δ @ | Stretch |
|---|---|---|---|---|---|---|
| Sample # | type | (N) | (%) | (%) | 80° C. | (mm) |
| 8 | Pea-A | 68.91 ± 16.57 | 110.60 ± 6.39 | 100.00 ± 0 | 0.775 | 28.77 |
| 9 | Lupin | 42.59 ± 7.38 | 5.60 ± 7.70 | 33.92 ± 13.20 | 0.357 | 28.00 |
| 10 | Pea-B | 29.57 ± 15.77 | 7.17 ± 11.14 | 56.07 ± 19.62 | 0.458 | 17.93 |
| 11 | Paba-A | 44.69 ± 5.19 | 15.00 ± 12.68 | 56.12 ± 13.30 | 0.446 | 20.60 |

Sample #8 had the greatest hardness value of ˜69N. The hardness values for samples #9-11 were much lower, ranging from 30-45N. The greater hardness of sample #8 was similar to medium cheddar dairy cheese. Regarding meltability, sample #8 had the greatest % spread reaching 110%. The ability for the sample to maintain good meltability at both T4 and T7 time points demonstrates that the sample composition plays an important role in functionality. Samples #9-11 had much lower melt ranging from 5-15%, which was decreased from T4. Regarding oil loss, sample #8 had the greatest oil loss reaching 100% saturation. Samples #10 and 11 showed less oil loss, with sample #9 having the least. The greater oil loss and greater hardness level of sample #8 closely align with the properties of medium cheddar dairy cheese. The rheological melting analysis demonstrated that sample #8 had the greatest tan n at 80° C. reaching 0.78 indicating the sample had the greatest melt and displayed more viscous behavior. Samples #9-11 had lower tan δ values ranging from 0.36-0.46, which was significantly better than current commercial plant-based cheeses. The stretch properties of the cheeses did change with the longer heating time. The stretch decreased for sample #8 to 29 mm, while samples #9-11 each exhibited slight increases in cheese melt.

Summary—The mechanical properties of the cheeses (samples #8-11) were generally consistent across both heating times, T4 and T7. Sample #8 was able to match the hardness of both processed dairy cheese and medium cheddar at both times. This sample displayed the greatest degree of melt/spread and highest tan δ at 80° C. indicating viscous behaviour in the melt and superior stretch. The differences in the functional properties can be attributed to the proteins used in each formulation. Sample #8 contained a protein with high protein purity and low solubility. These protein properties are associated with the mechanical properties of the cheese product. The protein acts as a passive filler due to the limited surface activity (i.e. low solubility), creating junction points in the network leading to increased network breakdown (i.e. better spread, melt and stretch).

In sample #9, the protein had high protein purity and high solubility. The solubility properties limit the hardness, spread and meltability of the sample. The greater solubility of the protein correlated to greater surface activity. The protein then has a tendency to create protein aggregates within the matrix. The aggregation of the protein limits the gelatinization and retrogradation ability of the starch and decreases the starch's connectivity of the sample network leading to poor melt and stretch.

The protein in sample #10 had low protein purity and low solubility. While the low solubility may suggest the ability for the protein to act as an inactive filler as seen in sample #8, this is not the case. Due to the low protein purity of the protein, there were greater amounts of additional carbohydrates and starches present. The additional starches coming from the protein are compositionally different from waxy maize present in the formulation. The starch coming from the protein contained amylose—a linear polysaccharide that when heated, such as in the cheese making proses, can interfere with gelatinization and results in a different gel structure causing limited melt and stretch properties. As seen in Table 4, the total amylopectin content of the cheese for sample #10 is much lower then sample #8 and 9. The reduced amylopectin content correlates to reduced melt and stretch.

The protein of sample #11 had low protein purity and high solubility. The properties of the protein combine the issues faced in sample #9 and #10. The high solubility can cause protein aggregation and the low protein purity can lead to additional starches being present. Additionally, the reduced amylopectin content (Table 4) correlates with reduced melt and stretch. Overall, both properties limit the hardness, melt, and stretch of the sample.

Thus, protein ingredients with high protein purity and low solubility appear to provide a cheese product with desirable functional properties.

### Example 4: Plant-Based Cheese Invention: Formulation 2

Novel cheese formulations comprising less than 10% by wt protein were prepared and evaluated for effect on the functional properties of the cheese. The base formulation for the low protein cheese samples #12-15 were as follows: 7.5% by wt protein, 21% by wt fat (refined coconut oil), 21.4% by wt starch (100% native waxy maize), 0.8% by wt salt and 49.7 by wt deionized water+acid. Citric or lactic acid was added to reach pH 4.2-4.5. The nutritional value of the cheese products made are set out in Table 8.

TABLE 8
Nutritional composition for plant-based cheese sample #12-15

| | | | Protein | Protein | | | Total | Amylopectin |
|---|---|---|---|---|---|---|---|---|
| | | Protein | ingredient | content | | Starch | carbohydrate | content of total |
| | Sample | purity | % | of cheese | Fat | content | content | carbohydrate |
| Sample # | Name | (%) | w/w | (%) | % | % | (%) | (%) |
| 12 | Pea-C (Pea | 82.80 | 7.5 | 6.21 | 21 | 21.4 | 22.69 | 94.5-93.4 |
| | Protein 85, | | | | | | | |
| | AGT Food) | | | | | | | |
| 13 | Pea-D | 79.03 | 7.5 | 5.93 | 21 | 21.4 | 22.97 | 94.2-92.9 |
| | (VITESSENCE ® | | | | | | | |
| | Pulse 1853, | | | | | | | |
| | Ingredion Inc) | | | | | | | |
| 14 | Faba-B | 61.01 | 7.5 | 4.58 | 21 | 21.4 | 24.32 | 92.8-90.6 |
| 15 | Chickpea | 56.80 | 7.5 | 4.26 | 21 | 21.4 | 24.64 | 92.4-90.1 |

Cheese samples #12-15 were prepared with an initial emulsion of an aqueous protein component (<5% w/w) and coconut oil. The remaining dry protein and starch were then added followed by a heated mixing regime comprising both low and high shear intervals as described in Example 1. Samples at time T6 were analyzed.

The properties of the different protein components in each of the samples are set out in Table 9 below.

TABLE 9
Categorization of protein ingredients in plant-based cheese samples # 12-15

| | | Protein | Protein | Protein | | Good |
|---|---|---|---|---|---|---|
| | Sample | purity | Solubility | Purity | Solubility | Cheese |
| Sample # | Name | (%) | (%) | <70% | @pH 5.5 | Properties |
| 12 | Pea-C | 82.80 | 3.6 | >70% | <30% | Y |
| | | | (pH 4.2) | | | |
| 13 | Pea-D | 79.03 | 36.8 | >70% | >30% | N |
| | | | (pH 7.9) | | | |
| 14 | Faba-B | 61.01 | 22 | <70% | <30% | N |
| | | | (pH 5) | | | |
| 15 | Chickpea | 56.80 | 24 | <70% | >30% | N |
| | | | (pH 4.2) | | | |

The functional properties for samples #12-15 were determined as described in Example 1 for samples having a protein content of less than 10%, and are shown below.

TABLE 10
Mechanical cheese properties sample #12-15

| | Protein | Hardness | Melt | Oil loss | tan δ @ | Stretch |
|---|---|---|---|---|---|---|
| Sample # | type | (N) | (%) | (%) | 95 C. | (mm) |
| 12 | Pea-C | 95 | 101 | 35 | 0.60 | 61 |
| 13 | Pea-D | 32 | 44 | 41 | 0.56 | 40 |
| 14 | Faba-B | 23 | 28 | 39 | 0.478 | 33 |
| 15 | Chickpea | 86 | 46 | 0 | 0.38 | 50 |

The hardness values for the samples ranged from 23-95N. Sample #12 containing protein with high purity and low solubility had the greatest hardness value. Samples #13-14 had lower hardness values. However, Sample #15 had a hardness value of 86 N, which can be attributed to the greater carbohydrate content (low protein purity). Hardness values were greater than commercial dairy and more comparable to current commercial plant-based cheese hardness. The melt/spread observed for Sample #12 was significantly greater at 101% than all commercial plant-based cheeses and was approaching values observed for dairy cheese. The oil loss of the samples ranged from 0-41%. The oil loss was lower than most of the samples in Example 2, likely due to the greater starch content in the current sample formulations. The rheological analysis for the samples was slightly different as the samples were shreds that were heated to 95° C. for the analysis. Sample #12 had the greatest tan δ value at 0.6, indicating good sample meltability and more hot melt viscous properties. Samples #13-15 had tan δ values that ranged form 0.38-0.56. The samples did have superior melt to all commercial plant-based samples. The stretch of the samples ranged from 61-33 mm. Sample #12 had the greatest stretch, however. Sample #13-15 also had considerably greater stretch than all commercial plant-based cheese, as well as the samples explored in Example 2. The greater stretch properties of the cheeses can be attributed to the greater amount of waxy starch in the formulation. The amylopectin content of the total carbohydrate component of samples #12-15 were all greater than 90%. With lower total protein contents of the cheese, stretch may overall be greater but can be enhanced by using a protein with high purity and low solubility so as to avoid aggregate formation.

The functional properties of the plant-based cheeses (Samples #12-15) were consistent with the results from plant-based cheese formulation explored in Example 2 (Sample #8-11). For sample #12, having a high protein purity and low solubility, displayed the best overall functionality with the greatest % melt, the greatest tan δ value indicating viscous behavior and the greatest stretch as compared to the other samples. These results are consistent with Sample #8 which also included a protein ingredient having high protein purity and low solubility.

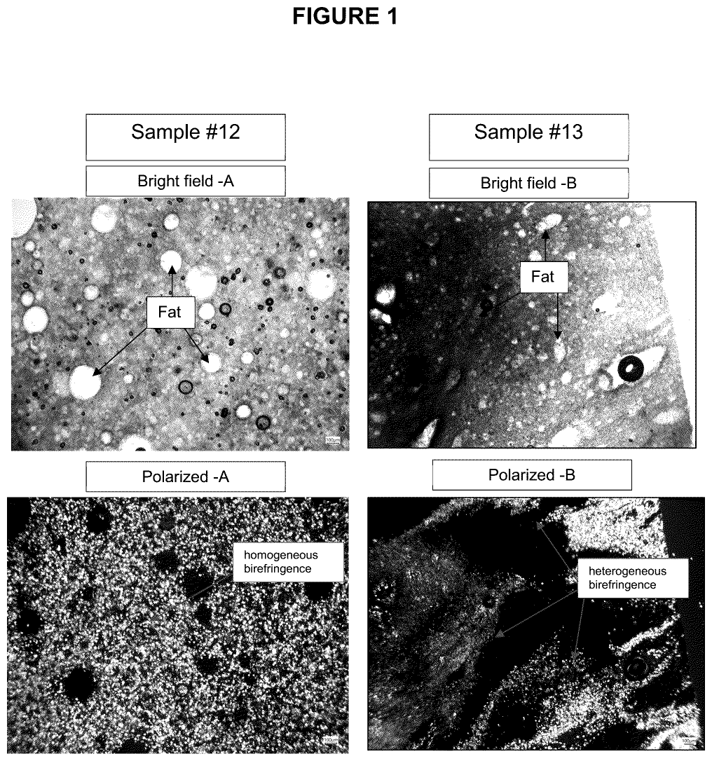

In sample #13, the protein in the formulation had high protein purity and high solubility. These properties limit the hardness, spread and meltability of the sample. High solubility results in the protein having more interaction potential creating protein aggregates within the matrix. This was shown in bright field and polarized microscopy images of Sample #12 and Sample #13 (see FIG. 1). In Bright field images of sample #12, there was a distribution of spherical fat globules while in Bright-field images of sample #13, the fat globules are more elongated due to the more surface active protein interacting with the fat and creating aggregates. The protein aggregation can be further identified in the polarized images. Polarized image of sample #12 displayed a homogenous distribution of birefringence (i.e. bright spots) (birefringence is a property from the starches were they refract light due to their crystalline structure). Polarized image of sample #13 displays heterogeneous birefringence. There are large sections where no visible light is present which corresponds to areas of protein aggregation.

Sample #14 and 15 which have low protein purity and low and high solubility, respectively, displayed similar limited melt and viscous properties to what was observed with low purity samples #10 and 11 of Example 2.

Overall, the formulations of Examples 1 and 2 demonstrate that a protein with high protein purity and low solubility is best suited for the cheese methods and create a product with superior nutrition and cheese functional properties (i.e., melt, stretch, hardness)

### Example 5: Amylopectin Content Effect on Cheese Functionality

The cheese formulation identified in Error! Reference source not found. was used to examine the effect of different starches on a cheese product. All samples were prepared with some or all of the following ingredients:
Pea Protein ingredient (7.5 w %)
Refined coconut oil (21 w %)
100% native waxy maize (21.4 w %)
Tapioca Starch
Corn Starch
Deionized water÷Lactic acid to reach desired pH (49.7 w %)
Salt

Each sample contained the same protein, which was a protein having high purity and low solubility, but the starch and amylopectin content varied as set out in Table 11. Total amylopectin values are an estimate based on literature values for tapioca starch=˜83% amylopectin and corn starch=˜70% amylopectin, and an estimate of the starch component from the protein ingredient. Total carbohydrate was 23.7 w % and total protein content of the cheese was 5.83 w %.

TABLE 11
Content of Formulation Samples #16-19

| | | | Protein | | | | Amylopectin | |
|---|---|---|---|---|---|---|---|---|
| | | | Solubility | | | | content of | Good |
| | | | @pH of | | | | total | Cheese |
| | Protein | Protein | cheese | | | | carbohydrate | Properties |
| Sample # | Name | purity | (%) | Starch 1 | Starch 3 | Starch 3 | (%) | (Y/N) |
| 16 | Pea-E | 77.60 | 1.09 | Waxy | / | / | 94.0-92.7 | Y |
| | (PURIS ® | | (pH 4.2) | maize | | | | |
| | Pea Protein | | | | | | | |
| | 870) | | | | | | | |
| 17 | Pea-E | 77.60 | 1.09 | Waxy | Tapioca | / | 86.5-85.2 | Y/N |
| | | | (pH 4.2) | maize | Starch | | | |
| 18 | Pea-E | 77.60 | 1.09 | Waxy | Tapioca | / | 83.2-81.9 | Y/N |
| | | | (pH 4.2) | maize | Starch | | | |
| 19 | Pea-E | 77.60 | 1.09 | Waxy | Tapioca | Corn | 80.7-79.4 | N |
| | | | (pH 4.2) | maize | Starch | Starch | | |

The functional properties of samples (#16-19) were determined as previously described. The results are summarized in Table 12.

TABLE 12
Mechanical properties of cheese: Effect of amylopectin content

| | | Amylopectin | | | | | |
|---|---|---|---|---|---|---|---|
| | | content of total | | | | | |
| | Protein | carbohydrate | Hardness | Melt | Oil loss | Tan δ @ | Stretch |
| Sample # | type | (%) | (N) | (%) | (%) | 95° C. | (mm) |
| 16 | Pea-E | 94.0-92.7 | 100.9 | 98 | 65.36 | 0.639 | 75.9 |
| 17 | Pea-E | 86.5-85.2 | 106.9 | 56 | 51.79 | 0.656 | 47.2 |
| 18 | Pea-E | 83.2-81.9 | 85.45 | 52 | 48 | 0.45 | 32 |
| 19 | Pea-E | 80.7-79.4 | 90.2 | 31 | 51.61 | 0.289 | 14 |

Sample #16 was considered to be the control sample containing 100% waxy maize starch as used in the formulations of Examples 2 and 3. The hardness values for the samples ranged from 106-85N. Samples #16 and #17 which had greater amounts of amylopectin had the greatest hardness levels. The hardness was the lowest for sample #18 and then slightly increased for sample #19 even though the amylopectin content decreased. This however can be attributed to the fact that corn starch was added instead of tapioca starch to the sample which tends to increase gel firmness.

Sample #16 had the greatest melt at 98% spread. Decreasing amylopectin as in samples #17-19 resulted in significantly decreased melt ranging from 31-56% spread.

Sample #16 had the greatest oil loss, and the oil loss decreased with decreasing amylopectin content. This could relate to the greater presence of amylose affecting the oil loss in the samples.

Sample #16 and #17 had high hot melt tan δ values at 0.64 and 0.66, respectively. The high hot melt tan δ values suggest that the samples with greater amylopectin contents melt to a greater extent and show more viscous properties. As the amylopectin content decreased to less than 85%, the tan δ values were significantly lower, suggesting the presence of amylose is affecting the meltability.

The extensibility of the samples was highly influenced by the amylopectin content. Sample #16 with 100% amylopectin displayed the greatest stretch reaching 76 mm. As the amylopectin content decreased in samples #17-19, the stretch also decreased from 47 mm to 14 mm. The limited stretch can be attributed to the increasing amylose present in the samples resulting in more structured cheese systems.

Overall, the results suggest that the cheese formulation has better functional properties when the carbohydrate portion is comprised of high amylopectin content. This further justifies the use of proteins with high purity in order to limit the presence of additional starches in the formulation which affecting the cheese functional properties.

### Example 6: Additional Formulations with High Purity Low Solubility Protein

Additional formulations comprising different proteins with high purity and low solubility (less than 10%) and different protein contents and starch contents were prepared as set out in Table 13. The samples were prepared according to the methods described in Example 1 (sample 20 was prepared by method 1 for product with protein content greater than 10%, and samples 21-23 were prepared by method 2).

TABLE 13
Additional formulations with high protein purity and low protein solubility

| | | | | | | | | | Amylopectin |
|---|---|---|---|---|---|---|---|---|---|
| | | | | Protein | Corrected | | Waxy | | content of |
| | | Protein | Protein | content | protein | | starch in | Total | total |
| | | purity | Solubility | % | content | Fat | formulation | Carbohydrate | carbohydrate |
| Sample # | Protein | (%) | (%) | w/w | (%) | % | % | (%) | (%) |
| 20 | Faba-C | 85.2 | 3 | 18 | 15.33 | 21 | 12 | 14.67 | 91.9-97.8 |
| | | | (pH 5.5) | | | | | | |
| 21 | Pea-F | 80.4 | 1.9 | 7.5 | 6.03 | 21 | 21.4 | 22.87 | 94.3-93.1 |
| | (Propulse ™ | | (pH 4.2) | | | | | | |
| | Pea Protein, | | | | | | | | |
| | NutriPea) | | | | | | | | |
| 22 | Lentil | 87.9 | 0.8 | 7.5 | 6.59 | 21 | 21.4 | 22.30 | 94.9-94.2 |
| | (Lentil | | (pH 4.2) | | | | | | |
| | Protein 80, | | | | | | | | |
| | AGT Food) | | | | | | | | |
| 23 | Pea-C | 82.80 | 3.6 | 10 | 8.28 | 21 | 18.9 | 20.62 | 93.7-92.2 |
| | | | (pH 4.2) | | | | | | |

The properties of these samples were determined as previously described, and the results obtained are set out in Table 14.

TABLE 14
Properties of additional formulations

| | Protein | Heating | Hardness | Melt | Oil loss | Tan δ @ | Stretch |
|---|---|---|---|---|---|---|---|
| Sample # | type | Time | (N) | (%) | (%) | 80-95 C. | (mm) |
| 20 | Faba-C | T7 | 54 | 108 | 90 | 0.545 | 33.5 |
| 21 | Pea-F | T6 | 103 | 124 | 51.4 | 0.567 | 61.17 |
| 22 | Lentil | T6 | 101 | 99 | 37 | 0.488 | 43.3 |
| 23 | Pea-C | T6 | 70.41 | 125.0 | 79.11 | 0.615 | 47.79 |

These samples exhibited good cheese properties over the range of proteins and protein contents.

As previously described, the present samples are made by heating/cooking for different durations of time as described in Methods 1 and 2 (Example 1). The length of heating time directly influences the sample hardness. However, the protein quantity/amount in each of the formulations can also affect the mechanical properties. To compare, samples #8, #21 and #23, prepared with the same heating time (T4, 20 minutes heating) were selected as each have different protein contents, the details of which are set out in Table 15.

TABLE 15
Nutritional composition for plant-based cheese samples of different protein contents

| | | | Solubility | Protein | | | Waxy | | Amylopectin |
|---|---|---|---|---|---|---|---|---|---|
| | | | of protein | in | Protein | | starch | | content of |
| | | Protein | at pH of | formulation | content | | in | Total | total |
| | Sample | purity | cheese | % | of cheese | Fat | formulation | Carbohydrate | carbohydrate |
| Sample # | Name | (%) | (%) | w/w | (%) | % | % | (%) | (%) |
| 8 | Pea-A | 77.62 | 4 | 18 | 14 | 21 | 12 | 16.00 | 89.2-84.7 |
| 21 | Pea-F | 80.4 | 1.9 | 7.5 | 6.03 | 21 | 21.4 | 22.87 | 94.3-93.1 |
| 23 | Pea-C | 82.80 | 3.6 | 10 | 8.28 | 21 | 18.9 | 20.62 | 93.7-92.2 |

As shown in Table 15, sample #8 contains more than double the amount of protein than sample #21, and sample #23 possesses an amount in between. The resulting mechanical properties of each of the cheese formulations is set out in Table 16.

TABLE 16
Mechanical cheese properties of cheese samples of different protein contents

| | | Protein in | | | | | | |
|---|---|---|---|---|---|---|---|---|
| | | formulation % | Heating | Hardness | Melt | Oil loss | tan δ @ | Stretch |
| Sample # | Protein | w/w | Time | (N) | (%) | (%) | 80-95 C. | (mm) |
| 8 | Pea-A | 18 | T4 | 21.34 | 120.40 | 92.86 ± 7.14 | 0.701 | 36.94 |
| 21 | Pea-F | 7.5 | T4 | 65.6 | 106 | 47 | 0.66 | 76.065 |
| 23 | Pea-C | 10 | T4 | 21.04 | 112.50 | 63.21 | 0.662 | 58.17 |
| 8 | Pea-A | 18 | T7 | 68.91 | 110.60 | 100.00 ± 0 | 0.775 | 28.77 |
| 21 | Pea-F | 7.5 | T6 | 103 | 124 | 51.4 | 0.567 | 61.17 |
| 23 | Pea-C | 10 | T6 | 70.41 | 125.0 | 79.13 | 0.615 | 47.79 |

### Results

The mechanical cheese properties of samples #8, 21 and 23 were compared to evaluate how the variable compositions affect the cheese properties.

Regarding hardness, at a heating time of T4=−20 min, sample #8 and 23 had similar hardness values which were both significantly lower than sample #21. Sample #8 and 23 also had similar hardness values at a heating time of 28 min (T7) for sample #8 and 26 min (T6) for sample #23. The hardness of the samples was again significantly lower than that of sample #21. The similar hardness values observed for samples #8 and 23, which have 18% w/w and 10% w/w protein, respectively, indicate that after 10% w/w protein there is very little change in hardness. The additional protein in sample #8 did not improve the properties of the cheese. Instead, it is shown that 10% w/w protein or less in the formulation results in a large range of hardness values can be achieved to coincide with different cheese types.

When comparing the melt properties, samples #8, 21, and 23 showed good melt properties achieving 100% spread or greater. The melt values are all significantly greater than commercial plant-based cheeses and are similar to the melt values of dairy cheese. These results suggest that greater amounts of protein are not needed to achieve superior melt properties.

Regarding oil loss, sample #8 exhibited significantly greater oil loss as compared to samples #21 and 23 at both preparation times, T4 and T7. The increased oil loss can be related to the significantly greater protein content of cheese sample #8.

The rheological melt analysis indicates that sample #8 at both preparation times, T4 and T7, have greater viscous properties than the other samples as indicated by the greater tan δ. However, the melt properties of sample #21 and 23 are still significantly greater than all commercial plant-based sample demonstrating that the lower protein content still provides acceptable melting properties.

Regarding stretch, sample #8 had significantly lower extensibility than samples #21 and 23, only reaching a maximum of ˜37 mm. In comparison sample #21 was able to extend greater than double the length to 74 mm. Stretch is an important property associated with cheese and is marketed as a desirable characteristic. The stretch of lower protein samples #21 and #23 has superior stretch and were able to reach values equal to or greater than tested dairy cheese.

### SUMMARY

By evaluating a variety of formulations, the effects of a range of protein contents on properties of the formulations and suitability for a cheese product were determined.

Samples #8, 23, and 21 contained 18% w/w, 10% w/w and 7.5% w/w protein, respectively. Samples #8 and 23 displayed very similar hardness values as well as similar % spread and rheological melt properties. Sample #23 however did exhibit less oil loss and superior stretch properties. The results indicate that greater than 10% w/w protein ingredient is not required in order to achieve good cheese characteristics. Additionally, sample #21, containing 7.5% w/w was able to achieve significantly greater hardness levels than samples #8 and 23 with shorter heating times while maintaining good melt properties, limited oil loss and significant levels of stretch.

Thus, the results provide that greater amounts of protein (i.e. >10% w/w) does not significantly enhance the hardness, cheese melt or stretch, indicating that the cost of making the present cheese product is made more economical by using reduced quantities of protein.

Further, from a manufacturing standpoint, shorter heating times to reach a desired hardness is preferred to reduce energy cost and avoid any degradation within the product that can occur with extended heating. This is beneficial since a cheese product with greater hardness levels permits desired post cheese manufacturing techniques such as, slicing and shredding, which require higher hardness levels to increase efficacy, for example, a hardness of at least about 60-100N.

### Example 7: Additional Formulations with High Purity Low Solubility Protein

Gums and pregelatinized starches are polysaccharides that can be used to increase viscosity and stabilize fat globules in an emulsion. They can also be utilized for their large swelling capacity which can lower the amount of native starch needed to create the cheese product. Cheese products were prepared using mixing method 2. The starch component was waxy tapioca and the fat component was (coconut oil). Additional polysaccharide ingredients (pre-gelatinized starch/gums) were added to the liquid fat portion prior to combining with the protein component to avoid clumping. The formulation is listed in Table 17.

TABLE 17
Polysaccharide ingredients in cheese formulation

| | | | Solubility | Protein | Corrected | | | | Total | Amylopectin |
|---|---|---|---|---|---|---|---|---|---|---|
| | | Protein | of protein | ingredient in | protein | | | Additional | Carbohydrate | content of |
| | | ingredient | at pH of | formulation | content | | Starch in | polysaccharide | (protein & starch | total |
| | Sample | purity | cheese | % | of cheese | Fat | formulation | in formulation | ingredients) | carbohydrate |
| Sample # | Name | (%) | (%) | w/w | (%) | % | % | % | (%) | (%) |
| 24 | Pea-F | 80.4 | 1.9 | 7.5 | 6.03 | 21 | 15 | 6.5 (pre-gel) | 22.97 | 86.9-85.7 |
| 25 | Pea-F | 80.4 | 1.9 | 8.0 | 6.43 | 22 | 16.25 | 0.5 (gums) | 18.35 | 90.9-89.4 |

The properties of the cheese products prepared are listed in Table 18.

TABLE 18
Mechanical cheese properties for samples #24-25 containing additional polysaccharides

| | | Additional | | | | | | |
|---|---|---|---|---|---|---|---|---|
| | Protein | polysaccharide | Heating | Hardness | Melt | Oil loss | Tan δ @ | Stretch |
| Sample | type | in formulation % | Time | (N) | (%) | (%) | 95 C. | (mm) |
| 24 | Pea-F | 6.5 (pre-gel | T6 | 150.4 | 155 | 97 | 0.633 | 56.7 |
| | | starch) | | | | | | |
| 25 | Pea-F | 0.5 (gums) | T6 | 90.6 | 86.2 | 68 | 0.521 | 40.2 |

### Results

Sample #24 contained pre-gelatinized tapioca starch (pre-gel) which replaced a portion of the native waxy tapioca. The pre-gel did not limit the mixing of the sample, and it was able to set into a solid cheese and reach desired hardness levels after refrigeration. The pre-gel starch increased the sample spread (about 155% melt) which was greater than some commercial dairy cheese. The sample also exhibited good rheological melt and significant stretch. The sample did display considerable oil loss, but paired with the superior melt, the sample was similar to a natural dairy cheese.

Sample #25, contained polysaccharide gums (1:1 xanthan and locust bean gum). The gums decreased the sample hardness and melt, but displayed good rheological melt, stretch and reduced oil loss. The gum significantly increased the perceived moisture of the cheese and increased its resilience. The addition of gums in a range of about between 0.1-1% would improve moisture-retaining properties of the cheese product.

1. A plant-based cheese product comprising a low solubility albumin- or globulin-based protein combined with starch and fat components in an aqueous solution, wherein the amylopectin content of the starch component is at least about 80% w/w.

2. The cheese product of claim 1, wherein the protein component exhibits a solubility of less than about 30% at a pH of 4-6.

3. The cheese product of claim 1, comprising about 1-25% w/w of the protein component, about 10-30% w/w of the fat component, and about 5-50% w/w of a carbohydrate component comprising carbohydrate from the protein component and the starch component.

4. The cheese product of claim 1, wherein the protein component comprises at least about 70% protein.

5. The cheese product of claim 1, wherein the protein component comprises less than about 20% of a non-amylopectin starch.

6. The cheese product of claim 1, wherein the fat component comprises unsaturated fat, saturated fat or a mixture thereof.

9. The cheese product of claim 1, having a hardness within a range of about 15-120N.

10. The cheese product of claim 1, having a tan δ (G″/G′) of at least about 0.4 at a temperature of at least 80° C.

11. The cheese product of claim 1, which exhibits a stretch as measured using a rotational rheometer of at least about 30 mm.

12. The cheese product of claim 1, which exhibits an increase in diameter at a temperature of at least 200° C. of at least 50% or greater.

13. The cheese product of claim 1, comprising an emulsifier in an amount of about 0.1% to about 1% by weight.

14. The cheese product of claim 13, wherein the emulsifier is a gum such as xanthan gum, locus bean gum, guar gum, Arabic gum, carrageenan, gellan gum, flaxseed gum, konjac gum or a mixture thereof.

15. The cheese product of claim 1, comprising a homogenous microstructure comprising spherical elements which are substantially evenly distributed throughout the product.

16. The cheese product of claim 1, wherein the starch component comprises a mixture of native starch and pregelatinized starch.

17. A method of making the plant-based cheese product comprising the steps of: i) combining protein and fat components in an aqueous solution, with or without an emulsifier and/or a starch component, to form an emulsion; ii) adding the starch component, if not added in step i) or optionally adding additional starch component, to the emulsion; and iii) heating the emulsion with stirring and shear for a period of time sufficient to yield a cheese product as defined in claim 1.

18. The method of claim 17, wherein the mixture is heated to a temperature sufficient to gelatinize the starch component.

19. The method of claim 18, wherein the temperature is within a range of about 60° C. to about 90° C.

20. The method of claim 17, wherein an emulsifier is combined with the protein and fat components.
